(19) United States
(12) Patent Application Publication
(10) Pub. No.: US 2015/0168173 A1
(43) Pub. Date: Jun. 18, 2015

(54) SYSTEM AND METHOD FOR MANAGING LOCATION OF ASSETS EQUIPPED WITH TRANSPONDER

(71) Applicant: Chinapac Limited, Kowloon (HK)

(72) Inventors: Jonathan Philip Lewis-Evans, Kowloon (HK); Alexander John Key, Kowloon (HK)

(21) Appl. No.: 14/413,338

(22) PCT Filed: Jun. 13, 2013
(86) PCT No.: PCT/CN2013/000692

§ 371 Date: Jan. 7, 2015

(30) Foreign Application Priority Data
Jul. 10, 2012 (HK) 12106752.1

(51) Int. Cl. G01C 21/36

(52) U.S. Cl. CPC G01C 21/3667

(57) ABSTRACT

A method is provided for locating an asset equipped with a transponder which issues coded signals when activated by a control communication received from a communication source or by a local event. The coded signals enable a tracking unit to direction find said asset. The method comprises the steps of: providing said tracking unit with map data compatible with a navigation system on-board the tracking unit; and displaying a location indicated by said map data on a map display of said navigation device, wherein said map data is indicative of a search location for the asset and the likely best route for recovery of the asset.

### FIELD OF THE INVENTION

The invention relates to a system and method for locating an asset equipped with a transponder where the transponder issues coded signals when activated by a control communication received from a communication source, wherein said coded signals enable a tracking unit to direction find said asset.

### BACKGROUND OF THE INVENTION

Known asset location and recovery systems typically provide a specialized locating device ‘LD’ to be associated with an asset such as a motor vehicle which a user, e.g. an ALSP (Asset Location Service Provider) subscriber, may wish to attempt to recover should it be moved without the user's permission, e.g. stolen. In the case of motor vehicles where this technology is best known, the LD is normally located at a secret location within the motor vehicle or at least in or at a part of the vehicle which is not easily accessible without undue effort. Placing the LD at a secret or difficult to access location is intended to prevent a thief from removing and discarding the LD from the asset during the course of stealing it. Preferably, the thief will not realize that the asset has a LD attached to it.

Some known asset locating and recovery systems enable the LD to use a radio network to communicate with an operations control centre ‘OCC’ which is sometimes referred to as a customer service centre ‘CSC’ or command and control centre ‘CCC’. The OCC is the management centre which manages subscribers and which controls asset location and recovery when a report or alert is received that an asset has been stolen, etc.

Existing asset location and recovery systems typically make use of a recovery vehicle or tracking vehicle which is directed to the expected location of a stolen asset either by the OCC or by an on-board device which provides radio frequency ‘RF’ direction finding information. This often comprises a signal strength indication and a detected signal direction relative to the recovery vehicle of the detected source of the signal, i.e. the stolen asset such as a motor vehicle.

The approximate location of the stolen asset may have been derived through a radio network and communicated to the recovery vehicle using a mobile telephone or another wireless communication device on board the recovery vehicle (tracking unit). The recovery vehicle proceeds to this approximate area and executes a search pattern looking for an RF device installed in the LD of the asset which, when activated, issues a coded signal. Typically, the information the driver of the recovery vehicle will receive is the signal strength of the detected signal presented in a numeric or bar format and a direction associated with the signal presented in a compass format with an arrow to indicate the direction from which the signal is emanating.

In some cases, the OCC may have access to a global positioning system ‘GPS’ location for the stolen asset. The OCC communicates location data derived from or associated with the GPS location such as a geographical description associated with the GPS coordinates to the driver of the recovery vehicle.

In both of these cases, the OCC has access to a more complete set of information regarding the location of the stolen asset and the driver of the recovery vehicle has only a limited view dependent on an on-going oral or data communication with the OCC. In addition, the OCC has access to road maps and routing information which is not usually available in the recovery vehicle. The OCC also has access to a complete description of the target asset including such things as make, model, license plate number, vehicle identification number ‘VIN’, colour, and possibly a photograph.

Furthermore, the OCC may be dealing with multiple recovery vehicles and multiple assets in recovery, leading to high likelihood of communication errors and a high requirement to communicate with each tracking vehicle very regularly. The OCC does not have a consolidated view of all direction finding information as such information is normally only available in each recovery vehicle.

The foregoing issues lead to considerable difficulties in managing and communicating with recovery vehicles in a timely and efficient manner and therefore achieving the recovery of the asset(s).

### SUMMARY OF THE INVENTION

In a first main aspect of the invention, there is provided a method of locating an asset equipped with a transponder which issues coded signals when activated by a control communication received from a communication source or by a local event, wherein said coded signals enable a tracking unit to direction find said asset, the method comprising the steps of: providing said tracking unit with map data compatible with a navigation system on-board the tracking unit; and displaying a location indicated by said map data on a map display of said navigation device, wherein said map data is indicative of a search location for the asset.

Preferably, the step of providing said tracking unit with map data compatible with a navigation system comprises the steps of: providing data indicative of a search location for the asset; and processing said search location data into map data compatible with said navigation system on-board the tracking unit. The tracking unit may be provided with the data indicative of a search location for the asset. Said processing of said search location data into map data compatible with said navigation system may be performed at the tracking unit.

Alternatively, the step of providing said tracking unit with map data compatible with a navigation system may comprise the steps of: receiving data indicative of a search location for the asset at the communication source, the communication source comprising an operations control centre ‘OCC’; processing said search location data into map data compatible with said navigation system on-board the tracking unit; and transmitting said map data from the OCC to the tracking unit.

Alternatively, the step of providing said tracking unit with map data compatible with a navigation system may comprise the steps of: at the communication source comprising an operations control centre ‘OCC” determining data indicative of a search location for the asset; processing said search location data into map data compatible with said navigation system on-board the tracking unit; and transmitting said map data from the OCC to the tracking unit.

Preferably, the step of providing said tracking unit with data indicative of a search location for the asset comprises providing data defining a geographical area in which the asset is expected to be located. The data defining a geographical area in which the asset is expected to be located may be determined from location finding techniques.

Preferably, the step of providing said tracking unit with data indicative of a search location for the asset comprises any one or more of: providing data defining a geographical area in which the asset is or was known to be located; providing data defining a geographical area in which a user of the tracking unit believes the asset is located; providing global positioning system ‘GPS’ data associated with the asset; providing historical location data for the asset; or providing location data derived from other devices or assets or communication systems identity data.

Preferably, the GPS data is provided by any one or any combination of a GPS unit on board the asset being tracked, the OCC, or any other device which together with the tracking unit and the OCC comprises an asset location system.

In practice, the data indicative of a search location for the asset usually comprises a best estimate of the location of the asset.

The search location may be a search location geographical area. The map display of the navigation device may display a road/street map image. The navigation system may display a satellite image displaying the search location. The navigation system may display a topological map image containing the search location. The navigation system may display locations of one or more other tracking units. The navigation system may display a recommended search route through a road/street map image displayed by the navigation system for the user of the tracking unit to follow. The recommended search route may comprise an optimum search pattern of the search area. The optimum search pattern of the search area may take account of any one or any combination of factors relating to the search area: permitted road directions, traffic congestion information, traffic light layout, traffic light responsiveness, speed limit data, radio frequency reception characteristics of the search area or other topical factors affecting the speed of transit. The navigation system may display previously followed search routes particularly where these cross or overlap parts of the recommended search route. The navigation system may display data about the asset such as type, make, colour, model, and/or identification data. The navigation system may display any of a serial or registration number, and/or markings on the asset such as logos or other branding or identifying marks or, where the asset is a vehicle, a vehicle registration number or a vehicle identification number ‘VIN’. The navigation system may display data about the asset on or around the map display image for easy viewing. The navigation system may display direction finding data on or in association with the map display image. The direction finding data may comprise data indicative of one or more of a detected direction at the tracking unit of coded signals emitted by the transponder of the asset being tracked and a signal strength of the detected coded signals.

Preferably, the navigation system on-board the tracking unit is remotely controlled by the communication source where the communication source comprises an operations control centre ‘OCC’.

Preferably, the navigation system of the tracking unit comprises a suitable configured conventional road/street navigation device.

In a second main aspect of the invention, there is provided an asset location system comprising: an operations control centre “OCC’; a tracking unit capable of receiving information from the OCC; an asset equipped with a transponder which issues coded signals when activated by a control communication received from the OCC or a local event, wherein said coded signals enable the tracking unit to direction find said asset, the system being configured to: provide said tracking unit with map data compatible with a navigation system on-board the tracking unit; and display a location indicated by said map data on a map display of said navigation device, wherein said map data is indicative of a search location for the asset. In a third main aspect of the invention, there is provided a tracking unit for an asset location system where the asset location system comprises an operations control centre ‘OCC’, the tracking unit and an asset equipped with a transponder which issues coded signals when activated by a control communication received from a communications source or a local event, wherein said coded signals enable the tracking unit to direction find said asset, the tracking unit comprising: means for receiving map data compatible with a navigation system on-board the tracking unit; and means for displaying a location indicated by said map data on a map display of said navigation device, wherein said map data is indicative of a search location for the asset.

In a fourth main aspect of the invention, there is provided an operations control centre ‘OCC’ for an asset location system where the asset location system comprises the OCC, a tracking unit capable of receiving information from the OCC and an asset equipped with a transponder which issues coded signals when activated by a control communication received from a communications source or a local event, wherein said coded signals enable the tracking unit to direction find said asset, the OCC comprising: means to provide said tracking unit with map data compatible with a navigation system on-board the tracking unit, wherein said map data is indicative of a search location for the asset.

The summary of the invention does not necessarily disclose all the features essential for defining the invention; the invention may reside in a sub-combination of the disclosed features.

### BRIEF DESCRIPTION OF THE DRAWINGS

The foregoing and further features of the present invention will be apparent from the following description of preferred embodiments which are provided by way of example only in connection with the accompanying figures, of which:

FIG. 1 is a schematic block diagram of an asset location system according to the invention;
FIG. 2 is a block schematic diagram of a locating device ‘LD’ for use in the system of FIG. 1;

FIG. 3 is a block schematic diagram of a location finder device based on a navigation unit for use in a tracking unit/recovery vehicle of the system of FIG. 1; and

FIG. 4 is a view of a display screen of the navigation unit of the location finder device of FIG. 3.

### DESCRIPTION OF PREFERRED EMBODIMENTS

The following description is of a preferred embodiment by way of example only and without limitation to the combination of features necessary for carrying the invention into effect.

Generally speaking, the invention concerns a system and method for an Asset Location Service Provider ‘ALSP’ to determine the location and the subsequent recovery of stolen assets such as motor vehicles, although the invention can equally well be used with other physical assets.

A physical asset may comprise: a motor vehicle of any type including an automobile, a boat, etc.; a person; an animal; cargo including containerized goods; manufacturing, construction or agricultural plant or machinery; bank money delivery boxes; or any other item that has value to an asset owner sufficient to warrant subscription to an asset location and recovery system for recovery of the asset in the event it is stolen or removed without the owner's permission. One skilled in the art will understand that the asset location system according to the invention merely requires a suitable locating device ‘LD’ to be associated with an asset of any type in order for the system to track and locate said LD and by inference the asset associated with the LD. The skilled person will also understand that, with the increasing miniaturization of electronic circuitry and devices, many opportunities arise for secreting a suitably adapted LD on or in an asset. This may involve integrating the LD into the asset to tap into the asset's power supply or it may involve providing the asset with an independent power supply, possibly comprising long life batteries or the like. In the case of a person, for example, the LD may be secreted in the lining of clothing or even secreted or integrated into a personal electronic product such as a laptop computer, personal digital assistant or mobile phone, for example. It may even be implanted under the skin as is already done with pets. A locating device as will be described hereinbelow is installed, worn or somehow associated with such an asset or a group of such assets. Where the assets are containerized, for example, the LD may be associated with the container or one of the group of containerized assets. Hereinafter, the description will refer to motor vehicles as the physical assets and theft as the cause or circumstance of unauthorized or unintended removal or loss merely by way of illustration only. It will be appreciated that other types of assets, stolen or lost under any other circumstances can also be tracked.

By private radio frequency network ‘PRFN’ is meant operational management control of a private radio/wireless system remains with the equipment owner, system administrator, or service provider.

Referring to FIG. 1, shown is a schematic block diagram of an asset location system 10 according to the invention. The system 10 comprises an operations control centre ‘OCC’ 12 for managing subscribers and for vehicle locating and recovery processes, a private radio frequency network ‘PRFN’ 14, a first motor vehicle 16, a second motor vehicle 18 and a recovery vehicle or tracking unit 20. The first and second vehicles 16, 18 are representative of a plurality of subscribers' vehicles. The OCC 12 may be a server-based system including means for processing computer readable instructions for implementing the methods hereinafter described. In some examples, the OCC 12 may include at least one database (not shown) for maintaining subscribers' data, etc. The processing means and computer readable instructions may be provisioned as suitable hardware and software resources which may be implemented in the form of computing devices having a storage and processing means for encoding stored computing instructions.

It will be understood that the recovery vehicle 20 could be replaced or supplemented by an airborne surveillance and tracking unit or system (not shown) or even replaced or supplemented by a satellite tracking system (not shown).

Associated with the asset location system 10 is a first public radio network 22 ‘PRN’ which preferably comprises a public mobile radio network ‘PMRN’ such as a GSM/GPRS network. The first PRN 22 is mentioned as being associated with the asset location system 10 rather than comprising part of said system as it comprises a public system accessible to any subscribers of the system 22 in a known manner and is not exclusive to the asset location system 10 or operated exclusively by or on behalf of the ALSP. The asset recovery system 10 may use as its primary communication medium the PMRN which is provided, maintained and operated by a different service provider to the asset location service provider ‘ALSP’, although, in some embodiments, the primary communication medium of the asset location system 10 may comprise the PRFN 14. In other embodiments, the PRFN 14 is a secondary communications medium of the system 10.

Also associated with the asset location system 10 is a second PRN 24 which preferably comprises one or more wireless local area networks ‘WLANs’ enabled to use the WiFi IEEE802.11 standard set of communication protocols, although it will be understood that the WLANs could comprise any type of WLAN or that the second PRN 24 may not comprise a WLAN but may comprise a second PMRN or some other type of PRN. Furthermore, the second PRN 24 may comprise one or more wireless metropolitan area networks ‘WMANs’ enabled to use the Wi-Max IEEE802.16 standard set of communication protocols. A WMAN has the advantage over a WLAN of greater area of coverage per WMAN. However, A WLAN has an advantage over a WMAN of being of a small size geographically such that any reported contact of a LD with a WLAN infers a small geographical search area for said LD based on the location of said WLAN. The second PRN 24 is also a publicly accessible, publicly provisioned system (free to use) or publicly subscribable-to system and is one which uses a different technology or communications protocol to that of the first PRN 22. The second PRN 24 may replace or augment the first PRN 22 and/or the PRFN 14. The second PRN 24 may comprise the secondary communications medium of the system 10 with the PRFN 14 comprising a tertiary communications medium of the system 10, although, in some embodiments, the second PRN 24 or the PRFN 14 comprises the primary and possibly only communication medium of the asset location system 10. The second PRN 24 may be linked directly to the OCC 12 or indirectly linked to the OCC 12 via the internet 26 or via a backbone communications system (not shown). The second PRN 24 may be enabled to convey internet protocol ‘IP’ communications between the first and second vehicles 16, 18 and the OCC 12 and the tracking vehicle 20.

The first vehicle 16 has a locating device 28 associated therewith. The second vehicle 18 also has a second LD 30 associated therewith. Whilst only two vehicles 16, 18 are shown, the system 10 has a plurality of subscribers each being provided with a respective LD for attaching to their respective vehicle (not shown). Each LD 28, 30 in the system 10 has a unique identifier or code to enable the OCC 12 to send and receive communications to and from said LDs 28, 30 and to identify and locate it. The first and second LDs 28, 30 may comprise transponders.

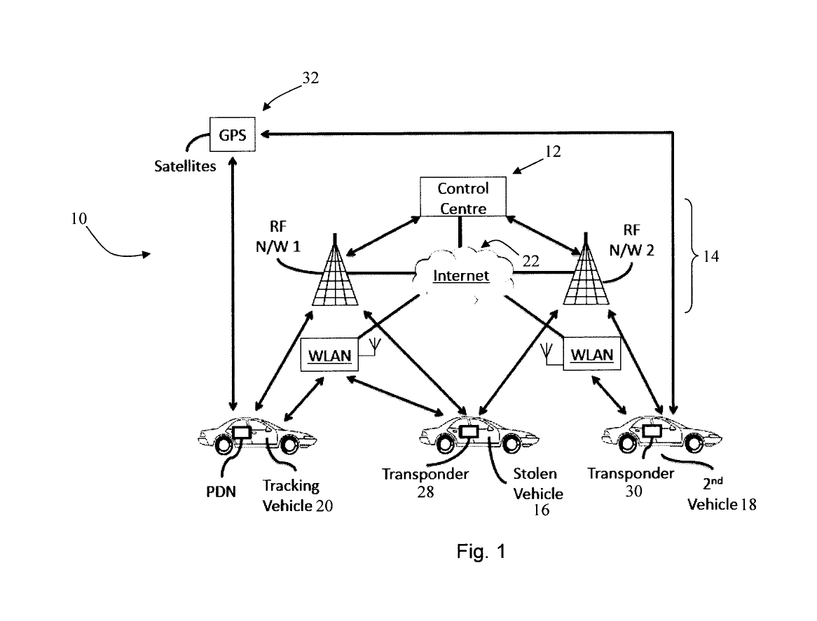

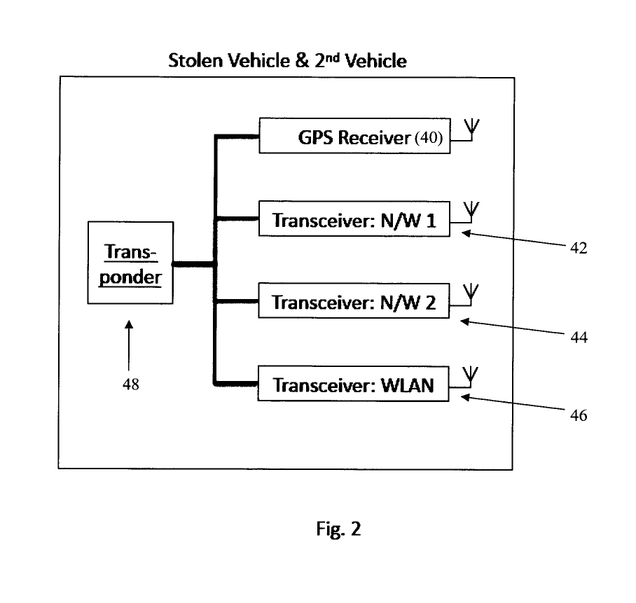

Also associated with the asset location system 10 is a global positioning satellite system ‘GPS’ 32. Each LD 28, 30 has a GPS receiver (FIG. 2) for receiving satellite signals from the GPS system 32 and processing circuitry enabling the LD to locally calculate its GPS position/location using the received GPS satellite signals.

It will be noted that, whilst many of the possible communication links between devices and systems depicted in the drawings are indicated by arrowed lines, not all possible communication links are shown for reasons of convenience and clarity.

FIG. 2 is a block schematic diagram of a typical LD 28, 30 for associating with a vehicle 16, 18 in the system 10 of the invention. The LD 28, 30 comprises a GPS receiver 40, a first wireless communication unit 42 enabled to communicate over the first PRN 22, a second wireless communication unit 44 enabled to communicate over the second PRN 24 using a different technology or protocol to that of the first PRN 22, a PRFN (transceiver) wireless communication unit 46 enabled to communicate over the PRFN 14, and control and processing circuitry 48 programmed with computer readable instructions for implementing the methods hereinafter described. The GPS receiver 40, the first wireless communication unit 42, the second wireless communication unit 44 and the PRFN wireless communication unit 46 are, when included in the LD 28, 30, interconnected with each other and the control and processing circuitry 48 such that message information received by one such unit can be passed to another such unit for processing and transmission over a suitable communications medium. For example, the GPS receiver 40 is able to receive GPS satellite signals and to forward these to the control and processing circuitry 48 to allow a local current GPS position of the vehicle 16, 18 to be calculated wherein the control and processing circuitry 48 is then able to pass the calculated local current GPS position data to any of the communication units 42, 44, 46 to enable local current GPS position data to be sent to any of the OCC 12, another LD 30 or the recovery vehicle 20.

This example embodiment may be advantageous in that data communicated between the GPS receiver 40, the communication units 42, 44 and 46, may be shared so as to improve the locating function of the LD 28, 30 or to improve the operating efficiency of each of the units or receivers.

It will be understood that the LD 28, 30 has at least one of the first wireless communication unit 42, the second wireless communication unit 44 and the PRFN wireless communication unit 46 as its preferred primary and possibly only means of wireless communication .

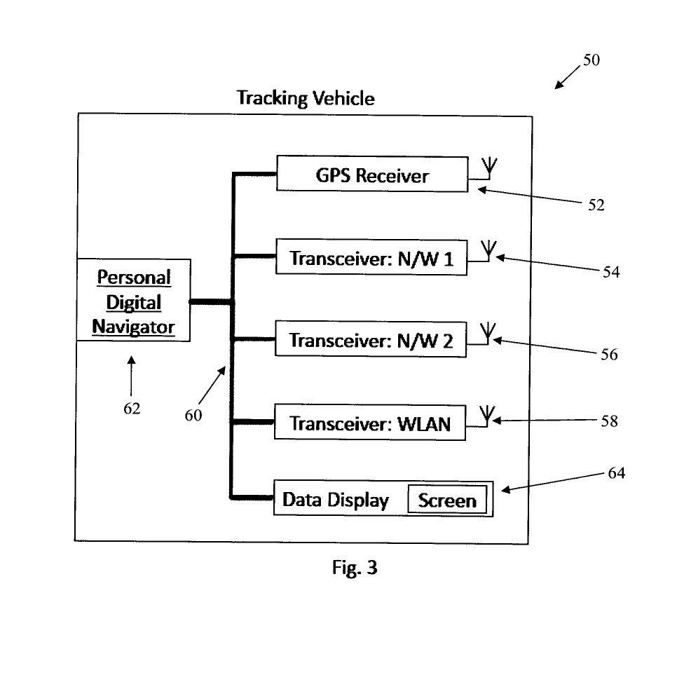

FIG. 3 is a block schematic diagram of a direction finding device ‘DF’ 50 for the recovery vehicle 20. The DF 50 comprises a GPS receiver 52, a first wireless communication unit 54 enabled to communicate over the first PRN 22, a second wireless communication unit 56 enabled to communicate over the second PRN 24 using a different technology or protocol to that of the first PRN 22, a PRFN (transceiver) wireless communication unit 58 enabled to communicate over the PRFN 14, and control and processing circuitry 60 programmed with computer readable instructions for implementing the methods hereinafter described. The GPS receiver 52, the first wireless communication unit 54, the second wireless communication unit 56 and the PRFN wireless communication unit 58 are, when included in the DF 50, interconnected with each other and the control and processing circuitry 60 such that message information received by one such unit can be passed to another such unit for processing and transmission over a suitable communications medium. For example, the GPS receiver 52 is able to receive GPS satellite signals and to forward these to the control and processing circuitry 60 to allow a local current GPS position of the recovery vehicle 20 to be calculated wherein the control and processing circuitry 60 is then able to pass the calculated local current GPS position data to any of the communication units 54, 56, 58 to enable local current GPS position data to be sent to the OCC 12 or another recovery vehicle 20.

The DF 50 has integrated or associated therewith a navigation unit 62 with a display 64 for displaying navigable maps such as road and street maps. The display 64 may be configured to also include a display section (not shown) showing a detected RF signal presented in a numeric or bar format and a direction associated with the signal presented in a compass format with an arrow to indicate the direction in which is signal is emanating.

The asset location system 10 is configured such that each LD 28, 30 has a PRFN transceiver (transmitter-receiver) wireless communication unit 46. The LDs 28, 30 are configured to use their respective PRFN communication units 46 to communicate directly over the PRFN 14 with any of the other LDs 28, 30 associated with other vehicles 16, 18 or the recovery vehicle 20 when a communication cannot be transmitted between said LDs 28, 30 and any of the OCC 12, other LDs 28, 30, or the recovery vehicle 20 using the PMRN 22.

In this arrangement of the system 10, the PRFN 14 may be used to transmit alerts, location information or activation/de-activation or other local function commands (such as audible alarms, fuel-cuts, door locking and the like) from the LDs 28, 30 at such times when the option to transmit over the PMRN 22 is unavailable due to localized PMRN jamming or PMRN coverage black spots.

In this arrangement of the system 10, the LDs 28, 30 of ALSP subscribers may be used to form a PRFN chain, capable of receiving and relaying short range RF transmissions from a stolen LD 28 and then forwarding that information, either continuing on the PRFN 14 in a daisy chain or by the PMRN 22, if available at another LD 30, in the daisy chain if that ALSP subscriber's LD 30 is not itself PMRN jammed or in a PMRN coverage black spot.

In this arrangement of the system 10, LDs 30 of other ALSP subscribers may be used to control the stolen LD 28 at short range via the daisy chained PRFN 14. Signals can be sent to all or a selected subset of subscriber LDs 30 via the PMRN 22 and these can then broadcast instructions to the stolen LD 28 via their own PRFN units 42. The OCC 12 can select a subset by using the unique identifiers assigned to the LDs 28, 30 to activate those that are conveniently located in or near the determined geographical search area.

In this arrangement of the system 10, the known location of a second subscriber LD 30 may be used as a proxy for the stolen LD's location. In the event of PMRN jamming, the recovery vehicle 20 can be sent to the proximity or current location of the proxy LD 30 which may be the vehicle 18 considered as being the closest to the last known location of the stolen vehicle 16. The recovery vehicle should then be able to receive a signal from the stolen LD 28 on the PRFN 14 and be able to locate the stolen vehicle 16 using direction finding or other known techniques familiar to the skilled artisan.

In operation of this arrangement, if the OCC 12 or a subscriber to the asset location system 10 becomes aware that, say, the first vehicle 16 may have been lost or stolen, the OCC 12 or said subscriber may request status and location data for the stolen first vehicle 16 through the PMRN 22. After a period of time, the OCC 12 will return to the requestor the status and location data for the stolen first vehicle 16 if this is has been received or is easily determinable. However, if no up to date status and location data is returned or easily determinable, the OCC 12 may examine a last known location of the first vehicle 16 and the time it was at that location. Based on the last known location and the elapsed time since the first vehicle 16 was at its last known location, the OCC 12 may determine a geographical area within which the stolen asset is expected to be currently located.

The OCC 12 then requests all other vehicles such as the second vehicle 18 and possibly the recovery vehicle 20 within the determined geographical search area to begin polling the first vehicle 16 requesting it to provide its current location and status. These other subscriber vehicles 18 and the recovery vehicle 20 if utilized preferably make requests on the PRFN 14 to avoid jamming on the PMRN 22. The transmissions from the other vehicles 18, 20 are preferably continued in a pre-programmed pattern or a pattern controlled by the OCC 12 through control messages forwarded to the vehicles 18, 20 located within the geographical search area until such time as the LD 28 of the first vehicle 16 acknowledges receipt of any one of the transmitted messages from any of the other vehicles 18, 20 and provides its location to the OCC 12 via the PMRN 22, the PRFN 14 or any other communication medium that may be determined as being available by the first vehicle LD 28. Alternatively or additionally, the LD 28 of the first vehicle 16 on receiving any of the messages from any of the other vehicles LDs 18, 20 or even from the OCC 12 provides its location information to another one of the vehicles LDs 30 or to the recovery vehicle 20 via the PRFN 14. The initial messages transmitted by the OCC 12 and the LDs 30 of the other vehicles 18, 20 may comprise an activation message which, when received by the LD 28 of the first vehicle 16, awakens the LD 28 and causes it to commence transmitting its location information in accordance with a pre-programmed sequence of transmissions on a selected communication medium or on any communication medium as determined locally as available by the LD 28 of the first vehicle 16.

The pattern of transmissions from the LDs 30 of other vehicles 18, 20, and the number of other LDs 30 selected to transmit within each sector of the identified geographical search area may be selected to maximize the possibility of contacting the first LD 28 of the first vehicle 16 while simultaneously minimizing the possibility of network degradation by colliding return transmissions from the LD 28 of the first vehicle 16 on the PRFN 14.

The OCC 12 may regularly expand the geographical search area and pool (subset) of other subscriber vehicles 18 looking for the stolen vehicle 16, as elapsed time since last confirmed location of the stolen vehicle 16 increases, to allow for additional distance the stolen vehicle may have travelled.

The LD 28 of the first ‘stolen’ vehicle 16 may be configured such that, when the first LD 28 receives such a request from another LD 30, or it determines locally through its control and processing circuitry 48 that the first vehicle 16 with which it is associated has been subject to unauthorized removal (e.g. stolen), it attempts to transmit its location and status by both the PMRN 22 and the PRFN 14. Furthermore, the LD 28 may be configured to self-activate to transmit its location and status upon locally determining that a theft situation may be in progress rather than awaiting receipt of an activation message from the OCC 12.

In the event that the OCC 12 or the recovery vehicle is able to receive location information direct from the LD 28 of the first vehicle 16 via the PMRN 22 or the PRFN 14 then a normal tracking and recovery procedure can be followed using the recovery vehicle 20 and/or a law enforcement agency.

If, however, the OCC 12 is not able to receive actual location information from the first LD 28, but is able to receive messages or at least a radio signal from the first LD 28 of the first vehicle 16 via the LD 30 of the second vehicle 18 over the PRFN 14 then a different tracking procedure may be implemented.

In this procedure, GPS location information from the stolen vehicle 16 and/or from any other vehicles 18 whose LDs 30 are able to communicate with the LD 28 of the first vehicle 16 are provided to the OCC 12 and/or the recovery vehicle 20. The other LDs 30 may use any suitable communication medium locally available to them to forward such GPS data to the OCC 12 and/or the recovery vehicle 20 including daisy chaining the information over the PMRN 22 and/or the PRFN 14 to other LDs of other vehicles. This process will either provide an accurate GPS location from the LD 28 of the first vehicle 16 itself or allow an approximate location to be calculated or deduced from the GPS location data reported by the other LDs. Consequently, the tracking and recovery vehicle 20 can be sent to the location, which can be kept updated as updated GPS location data is reported to the OCC 12 and/or tracking vehicle 20.

In the absence of accurate GPS location data from the LD 28 of the first vehicle 16 itself, the LD 28 may be configured to poll nearby LDs 30 using the PRFN 14 to determine locally its approximate current location using signal triangulation or other known techniques. The LD 28 having made such a local calculation or determining of its approximate location may transmit this information to the OCC 12 or the recovery vehicle 20 either via the PMRN 22 if that becomes locally available or via the PRFN 14 via one or more other nearby LDs 30 via a daisy chain or ad-hoc network RF connection whereby such approximate location information helps the OCC 12 and/or the recovery vehicle 20 to narrow the search area.

Furthermore, the LD 28 of the first vehicle may be configured to measure signal strength from nearby LDs 30 and to use said received signal strength ‘RSS’ measurements to approximate its location. Alternatively, the other LDs may be configured to take respective signal strength measurements of the first LD 28 over the PRFN 14 and to report these to the OCC 12 and/or the recovery vehicle 20 such that said OCC 12 or recovery vehicle 20 can use the RSS measurements to calculate an approximate location for the first LD 28. Such a calculation may be useful where the GPS receiver of the first LD 28 is being jammed or the GPS receiver is otherwise unable to receive sufficient GPS signals to determine its current GPS location.

The recovery vehicle 20 may, in the absence of an actual GPS location for the first LD 28 use radio direction finding on a signal transmitted by the first LD 28 on the PRFN 14 to determine the current location of the first LD 28 and, by inference, the first vehicle 16. In the event that the PRFN 14 is being locally jammed by a thief s high power jamming equipment in the first vehicle 16 during the course of stealing it, the ASLP would be able to track the local jamming signal, thus allowing the first vehicle to be located using the thief's RF jamming signal.

Even where an accurate location such as GPS data coordinates for the first vehicle 16 are obtained or derived from some source, it is still often necessary to have the recovery vehicle 20 execute a search using directing finding techniques in an area within which the GPS position is located. This is partly because the direction finding data is itself prone to errors and partly because the stolen vehicle 16 may be hidden in a garage or the like and therefore cannot be visibly identified at the location indicated by the GPS location data and/or direction finding data. Or, where no accurate location such as GPS data coordinates is available, then the use of the recovery vehicle 20 in executing a search pattern in a search area becomes necessary in order to locate the stolen vehicle 16 as quickly as possible.

Therefore, in accordance with the invention, the recovery vehicle 20 has integrated or associated with its direction finding device ‘DF’ 50 a navigation unit 62 to display a search area in which the recovery vehicle 20 is to execute a search. The recovery vehicle executes a direction finding search procedure by seeking to detect coded signals issued by the LD 28 of the stolen vehicle 16 when activated by a control communication received from the OCC 12 or a local event.

A significant problem in executing an effective direction finding based search is to identify an initial location around which the search is to be conducted and/or an initial area within which to search in a form that can preferably be presented to and understood by the crew of the recovery vehicle in real time. Another problem is to perform the direction finding in the initial search area as efficiently as possible.

In accordance with the invention, the recovery vehicle 20 is provided with map data compatible with the navigation device 62 on-board the recovery vehicle 20 such that a location indicated by said map data can be immediately displayed on the map display 64 of said navigation device 62 without intervention by the crew of the recovery vehicle. Consequently, the map data provided to the recovery vehicle 20 is indicative of a search location or area for the stolen vehicle 16. The user of the recovery vehicle 20 can then plan a search in the area around the displayed location on the navigation device map display 64.

The method may involve providing search location data such as GPS coordinates or any other search location data derived from other sources to the recovery vehicle DF 50 and configuring the DF 50 to process said search location data into a form compatible with said navigation device 62. The advantage of this step is to move processing of the raw search location data from another source such as the OCC 12 to the recovery vehicle 20 which requires said search location data.

Alternatively, processing said search location data into a form compatible with said navigation device 62 may be performed by the OCC 12 which then transmits said map data to the recovery vehicle 20 in a form compatible with the navigation device 62 such that it can be displayed on said device's display screen 64 without further significant processing by the DF 50 of the recovery vehicle 20. This assists the OCC 12 in keeping the recovery vehicle 20 provided with accurate up to date search location data for display on the screen 64 of the navigation device 62.

In one embodiment, the data indicative of a search location of the stolen vehicle 16 comprises data defining a geographical area in which the stolen vehicle 16 is expected to be located and this data may be derived from any of: data defining a geographical area in which the stolen vehicle 16 is or was known to be located; data defining a geographical area in which a user of the recovery vehicle 20 believes the stolen vehicle 16 is located; global positioning system ‘GPS’ data associated with the stolen vehicle; historical location data for the stolen vehicle; or location data derived from other devices or vehicles or communication systems identity data. However, the data indicative of a search location of the stolen vehicle 16 may simply comprise a best estimate location for the stolen vehicle 16 made by the user of the recovery vehicle 20, an operator of the OCC 12 or a law enforcement officer.

In one embodiment, the operations control centre 12 (OCC) may be configured to identify a possible search area for the recovery vehicle 20 to use in tracking the first LD 28. This may be based on a last known location of the first LD 28 and taking into account data such as elapsed time since said last known location was received and/or a last known time said asset was at its last known location. The operations control centre 12 may be configured to use timing information contained in or derivable from communications received from other LDs 30 associated with other assets 18 which have communicated at some point in time with the first LD 28 to determine a potential search area or starting location or position for the recovery vehicle 20. Additionally or alternatively, the OCC 12 may be configured to receive direction finding data from fixed or mobile listening posts or stations installed or operating within the area of the asset location system 10 whereby such listening posts or stations are configured to detect the coded signals emitted by LDs and to obtain direction finding data such as signal strength and direction through detection of such coded signals. The mobile listening posts may comprise suitably equipped vehicles.

Where GPS data is available, this may be provided by any one or any combination of a GPS unit on board the stolen vehicle 16, the OCC 12, or any other vehicle 18 in the asset location system 10.

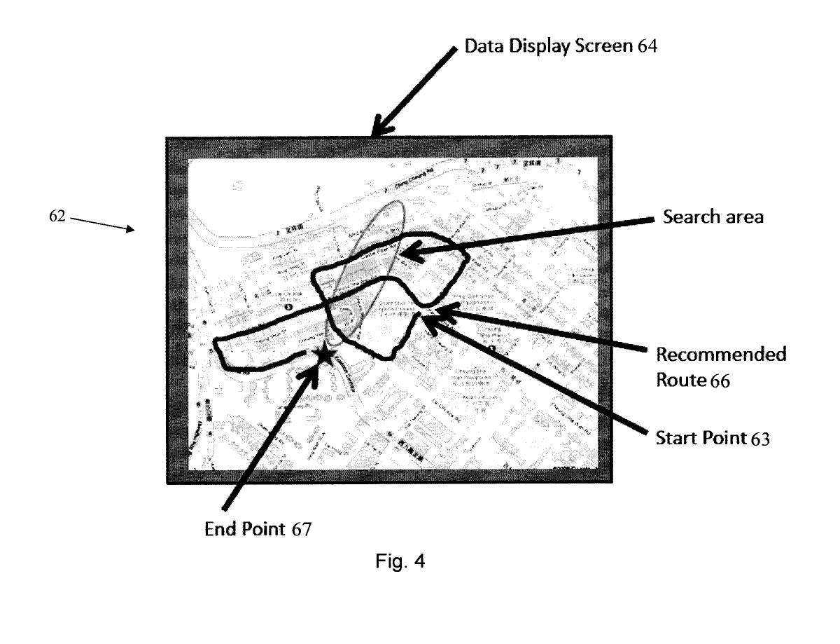

The navigation device 62 may comprise a commonly available commercial navigation unit of the type often installed in rental cars, but suitably configured to include a display section (not shown) for displaying direction finding data output by the DF 50 of the recovery vehicle 62. The initial or starting search location may be a geographical search area 65 rather than a precise location for displaying on the navigation screen 64 of the navigation device 62. In such a case, the navigation device may be adapted to display said area 65 in a manner which highlights said area such as illustrated in FIG. 4, for example. The map display 64 of the navigation device 62 preferably comprises a road/street map image, but the navigation device may additionally or alternatively display a satellite image displaying the search location or area. In the case where the satellite image is additionally displayed to a usual navigation device road/street map image, the satellite image may be overlaid with the road/street map image and have a level of opacity which enables the user to still view the underlying road/street map image. The navigation device 62 may also display a topological map image containing the search location or area. The navigation device 62 may be configured to display locations of one or more other recovery vehicles in addition to its own location.

The navigation device 62 may be configured to calculate and display a recommended search route 66 (FIG. 4) through a road/street map image displayed by the navigation device 62 for the user of the recovery vehicle 20 to follow. The search route 66 comprises as its starting point the present location 63 of the recovery vehicle 20 and an end location 67. The navigation device is configured to issue direction instructions to assist the recovery vehicle operator in travelling along the search route 66 in a like manner to a conventional user of a navigation system following a route calculated to a specified destination. The recommended search route 66 may comprise an optimally calculated search pattern of the search area. The navigation device 62 may be configured to calculate the optimum search pattern of the search area by taking account of any one or any combination of factors relating to the search area: permitted road directions, traffic congestion information, traffic light layout, traffic light responsiveness, speed limit data, radio frequency reception characteristics of the search area or other topical factors affecting the speed of transit. However, the search route through the search area may be calculated at the OCC 12 and transmitted to the DF 50 of the recovery vehicle 20. The navigation device 62 may also display previously followed search routes particularly where these cross or overlap parts of the recommended or newly calculated search route. The navigation device 62 may be configured to display data about the stolen vehicle 16 such as type, make, colour, model, and/or identification data. The navigation device 62 may display any of a serial or registration number, and/or markings on the stolen asset such as logos or other branding or identifying marks or, where the asset is a vehicle 16, a vehicle registration number or a vehicle identification number ‘VIN’. The navigation device 62 may also display data about the stolen vehicle 16 on or around the map display image for easy viewing.

The navigation device 62 on-board the recovery vehicle may be configured to be remotely controlled by the OCC 12 whereby the OCC 12 can update the search location or area being displayed by said navigation device 62 and may update the search route to be followed by the recovery vehicle 20 when direction finding the coded RF signal being emitted by the stolen vehicle 16.

Each recovery vehicle in the asset location system equipped with a navigation device as hereinbefore described may be configured to enable the user of that vehicle to choose to display all search area and recovery route information of one or more of the other recovery vehicles thereby enabling the user to better judge how to perform a direction finding search pattern that assists the efforts of other such recovery vehicle users/operators. However, the OCC 12 may be configured to disable this feature so as to ensure that an operator of a recovery vehicle concentrates on performing their assigned search and are not distracted by the activities of other recovery vehicles.

The navigation device 62 may be configured to control the DF 50 frequency of operation to allow for the use of many different frequencies supported by the DF 50.

It can be seen therefore that the present application defines a method of locating an asset equipped with a transponder which issues coded signals when activated by a control communication received from a communication source or by a local event, wherein said coded signals enable a tracking unit to direction find said asset, the method comprising the steps of:

providing said tracking unit with map data compatible with a navigation system on-board the tracking unit; and displaying a location indicated by said map data on a map display of said navigation device, wherein said map data is indicative of a search location for the asset.

It can also be seen that the present application defines an asset location system comprising:

an operations control centre “OCC’; a tracking unit capable of receiving information from the OCC; an asset equipped with a transponder which issues coded signals when activated by a control communication received from the OCC or by a local event, wherein said coded signals enable the tracking unit to direction find said asset, the system being configured to: provide said tracking unit with map data compatible with a navigation system on-board the tracking unit; and display a location indicated by said map data on a map display of said navigation device, wherein said map data is indicative of a search location for the asset.

It can also be seen that the present application defines a tracking unit for an asset location system where the asset location system comprises an operations control centre ‘OCC’, the tracking unit and an asset equipped with a transponder which issues coded signals when activated by a control communication received from a communications source or by a local event, wherein said coded signals enable the tracking unit to direction find said asset, the tracking unit comprising: means for receiving map data compatible with a navigation system on-board the tracking unit; and means for displaying a location indicated by said map data on a map display of said navigation device, wherein said map data is indicative of a search location for the asset.

It can also be seen that the present application defines an operations control centre ‘OCC’ for an asset location system where the asset location system comprises the OCC, a tracking unit capable of receiving information from the OCC and an asset equipped with a transponder which issues coded signals when activated by a control communication received from a communications source or by a local event, wherein said coded signals enable the tracking unit to direction find said asset, the OCC comprising: means to provide said tracking unit with map data compatible with a navigation system on-board the tracking unit, wherein said map data is indicative of a search location for the asset.

In some arrangements of the system 10 of the invention, the proposed PRFN communication unit 46 in each LD may be replaced by a WiFi or Wi-Max enabled transceiver (the second wireless communication unit 44). Use of WiFi or Wi-Max has significant other ancillary advantages. It enables the ALSP to easily configure or update the LD 28, 30 inside the vehicle 16, 18 without removal because of the higher data transfer speeds available using WiFi or

Wi-Max than is the case for PRFN transceivers. For example, software updating of LDs could be performed wirelessly over any of the wireless networks rather than locally at each LD. It would also enable the use of commercially available WiFi or Wi-Max sniffer devices to be utilized to determine RSS measurements for tracking or approximate location calculation purposes or to obtain one or more SSIDs from wireless networks being traversed by the LD of a stolen asset.

In this latter arrangement where the LD is enabled to ‘sniff’ out SSIDs or the like, the LD may be arranged to either: a) determine locally an approximate location for said LD based on said obtained identifier data; or b) transmit said obtained identifier data to another device in the asset location system to enable said other device to determine remotely an approximate location for said LD based on said obtained identifier data.

This arrangement is advantageous in that it makes use of publicly obtainable information from public networks and publicly available knowledge of the location of said networks or fixed position devices within said networks to enable a LD to either locally determine its approximate location using said obtained information or to pass said obtained information on to another device in the asset location system to have said approximate location determined locally. In such a case, the LD may not necessarily be enabled to communicate over the wireless network but simply enabled to ‘sniff’ out SSIDs.

Where a wireless network is a publicly subscribable-to or publicly provisioned (free to use) network it has fixed devices such as access points, routers, base stations which are assigned unique identifiers. The locations of the devices with such identifiers are often publicly known, being commonly available through services such as Google maps or the like. Therefore, as indicated above, a LD enabled to sniff out SSIDs or other unique identifiers for fixed assets of known geographical location can use the obtained identifier data to either locally access location data associated with said identifier data and determine its approximate location or to transmit said identifier data to the OCC or the mobile location tracking system such that these devices can remotely (to the LD) determine its approximate location. It will be understood that a single SSID or other identifier data could still enable a small geographical search area to be determined for locating the LD or, where two or more SSIDs or identifier data are obtained, to triangulate the locations associated with said data and determine fairly accurate a location for the LD.

In some arrangements of the system 10 of the invention, the recovery vehicle 20 may be configured to cause the LD 28 of the first vehicle 16 being tracked as stolen to activate in the vehicle 16 an audible alarm preferably of a high decibel level to allow the vehicle to be pinpointed using the audible alarm signal. The recovery vehicle 20 may be configured to cause activation of the LD 28 to initiate the audible alarm when the recovery vehicle is or considers that it is in close proximity to the tracked location of the first vehicle 16. The recovery vehicle 20 may also use such a signal to implement fuel cut off in the first vehicle 16.

In some arrangements of the system 10 of the invention, the other LDs 30 that assist in daisy chaining PRFN signals between the LD 28 and the OCC 12 and/or recovery vehicle 20 may be configured to only communicate using the PRFN 14 when they determine locally that they cannot communicate over alternative PRN communication means. In such a case, the Ms 30 may be configured to communicate only minimal information over the PRFN 14 in order not to saturate the PRFN RF channels, but are configured to save unsent data until they again determine that another communication medium such as a PRN has become available whereby they then send the saved information to the OCC 12 and/or tracking vehicle 20.

In general, some embodiments of the invention provide a method for locating an asset equipped with a transponder which issues coded signals when activated by a control communication received from a communication source or by a local event. The coded signals enable a tracking unit to direction find said asset. The method comprises the steps of: providing said tracking unit with map data compatible with a navigation system on-board the tracking unit; and displaying a location indicated by said map data on a map display of said navigation device, wherein said map data is indicative of a search location for the asset and the likely best route to recovery of the asset.

In some embodiments, the system for locating an asset is arranged to mitigate or obviate to some degree one or more problems associated with known methods, apparatuses and systems for locating an asset equipped with a transponder which issues coded signals when activated by a control communication received from a communication source or by a local event, wherein said coded signals enable a tracking unit to direction find said asset.

While the invention has been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art, in Australia or any other country.

1. A method of locating an asset equipped with a transponder which issues coded signals when activated by a control communication received from a communication source or by a local event, wherein said coded signals enable a tracking unit to direction find said asset, the method comprising the steps of:
providing said tracking unit with map data compatible with a navigation system on-board the tracking unit; and
displaying a location indicated by said map data on a map display of said navigation device,
wherein said map data is indicative of a search location for the asset.

2. The method of claim 1, wherein the step of providing said tracking unit with map data compatible with a navigation system comprises the steps of:
providing data indicative of a search location of the asset; and
processing said search location data into map data compatible with said navigation system on-board the tracking unit.

3. The method of claim 2, wherein the tracking unit is provided with the data indicative of a search location of the asset and said processing of said search location data into map data compatible with said navigation system is performed at the tracking unit.

4. The method of claim 1, wherein the step of providing said tracking unit with map data compatible with a navigation system comprises the steps of:
receiving data indicative of a search location of the asset at the communication source, the communication source comprising an operations control centre ‘OCC’;
processing said search location data into map data compatible with said navigation system on-board the tracking unit; and
transmitting said map data from the OCC to the tracking unit.

5. The method of claim 1, wherein the step of providing said tracking unit with map data compatible with a navigation system comprises the steps of:
at the communication source comprising an operations control centre ‘OCC” determining data indicative of a search location of the asset;
processing said search location data into map data compatible with said navigation system on-board the tracking unit; and
transmitting said map data from the OCC to the tracking unit.

6. The method of claim 1, wherein the step of providing said tracking unit with data indicative of a search location of the asset comprises providing data defining a geographical area in which the asset is expected to be located.

7. The method of claim 6, wherein the data defining a geographical area in which the asset is expected to be located is determined from location finding techniques.

8. The method of claim 1, wherein the step of providing said tracking unit with data indicative of a search location of the asset comprises providing data defining a geographical area in which the asset is or was known to be located.

9. The method of claim 1, wherein the step of providing said tracking unit with data indicative of a search location of the asset comprises providing data defining a geographical area in which a user of the tracking unit believes the asset is located.

10. The method of claim 1, wherein the step of providing said tracking unit with data indicative of a search location of the asset comprises providing global positioning system ‘GPS’ data associated with the asset.

11. The method of claim 10, wherein the GPS data is provided by any one or any combination of a GPS unit on board the asset being tracked, the OCC, or any other device which together with the tracking unit and the OCC comprises an asset location system.

12. The method of claim 1, wherein the step of providing said tracking unit with data indicative of a search location of the asset comprises providing historical location data for the asset.

13. The method of claim 1, wherein the step of providing said tracking unit with data indicative of an search location of the asset comprises providing location data derived from other devices or assets or communication systems identity data.

14. The method of claim 6, wherein the data indicative of an search location of the asset includes a best estimate location for the asset.

15. The method of claim 1, wherein the search location is a search location geographical area.

16. (canceled)

17. (canceled)

18. (canceled)

19. (canceled)

20. (canceled)

21. (canceled)

22. The method of claim 1, wherein the a recommended search route displayed by the navigation system comprises an optimum search pattern of the search area takes account of any one or any combination of factors relating to the search area: permitted road directions, traffic congestion information, traffic light layout, traffic light responsiveness, speed limit data, or radio frequency reception characteristics of the search area, other topical factors affecting the speed of transit.

23. (canceled)

24. (canceled)

25. (canceled)

26. (canceled)

27. (canceled)

28. (canceled)

29. (canceled)

30. (canceled)

31. An asset location system comprising:
an operations control centre “OCC’;
a tracking unit capable of receiving information from the OCC;
an asset equipped with a transponder which issues coded signals when activated by a control communication received from the OCC or by a local event, wherein said coded signals enable the tracking unit to direction find said asset, the system being configured to:
provide said tracking unit with map data compatible with a navigation system on-board the tracking unit; and
display a location indicated by said map data on a map display of said navigation device,
wherein said map data is indicative of a search location for the asset.

32. The system of claim 31, wherein the system is configured to provide said tracking unit with map data compatible with a navigation system by:
providing data indicative of a search location of the asset; and
processing said search location data into map data compatible with said navigation system on-board the tracking unit.

33. The system of claim 32, wherein the system is configured to provide the tracking unit with the data indicative of a search location of the asset and said tracking unit is configured to process said search location data into map data compatible with said navigation system.

34. The system of claim 31, wherein the system is configured to provide said tracking unit with map data compatible with a navigation system by:
receiving data indicative of a search location of the asset at the OCC;
processing said search location data into map data compatible with said navigation system on-board the tracking unit; and
transmitting said map data from the OCC to the tracking unit.

35. The system of claim 31, wherein the system is configured to provide said tracking unit with map data compatible with a navigation system by:
at the OCC, determining data indicative of a search location of the asset;
processing said search location data into map data compatible with said navigation system on-board the tracking unit; and
transmitting said map data from the OCC to the tracking unit.

36. The system of claim 31, wherein the system is configured to provide said tracking unit with data indicative of a search location of the asset by providing data defining a geographical area in which the asset is expected to be located.

37. The system of claim 36, wherein the system is configured to determine the data defining a geographical area in which the asset is expected to be located from location finding techniques.

38. The system of claim 31, wherein the system is configured to provide said tracking unit with data indicative of a search location of the asset by providing data defining a geographical area in which the asset is or was known to be located.

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. A tracking unit for an asset location system where the asset location system comprises an operations control centre ‘OCC’, the tracking unit and an asset equipped with a transponder which issues coded signals when activated by a control communication received from a communications source or by a local event, wherein said coded signals enable the tracking unit to direction find said asset, the tracking unit comprising:
means for receiving map data compatible with a navigation system on-board the tracking unit; and
means for displaying a location indicated by said map data on a map display of said navigation device,
wherein said map data is indicative of a search location for the asset.

62. The tracking unit of claim 61, wherein the tracking unit is configured to receive data indicative of a search location of the asset and to process said search location data into map data compatible with said navigation system.

63. The tracking unit claim 61, wherein the tracking unit is configured to receive data indicative of a search location of the asset, said data comprising any of: data defining a geographical area in which the asset is expected to be located; data defining a geographical area in which the asset is known to be located; data defining a geographical area in which a user of the tracking unit believes the asset is located; global positioning system ‘GPS’ data associated with the asset; historical location data for the asset; or location data derived from other devices or assets or communication systems identity data.

64. (canceled)

65. (canceled)

66. (canceled)

67. (canceled)

68. (canceled)

69. (canceled)

70. (canceled)

71. (canceled)

72. An operations control centre ‘OCC’ for an asset location system where the asset location system comprises the OCC, a tracking unit capable of receiving information from the OCC and an asset equipped with a transponder which issues coded signals when activated by a control communication received from a communications source or by a local event, wherein said coded signals enable the tracking unit to direction find said asset, the OCC comprising:
means to provide said tracking unit with map data compatible with a navigation system on-board the tracking unit, wherein said map data is indicative of a search location for the asset.

73. The OCC of claim 72, wherein the OCC is configured to provide said tracking unit with map data compatible with a navigation system by:
receiving data indicative of a search location of the asset;
processing said search location data into map data compatible with said navigation system on-board the tracking unit; and
transmitting said map data OCC to the tracking unit.

74. (canceled)

75. (canceled)

76. (canceled)
